(19) United States
(12) Patent Application Publication
(10) Pub. No.: US 2016/0167399 A1
(43) Pub. Date: Jun. 16, 2016

(54) INKJET PRINTER, INKJET PRINTING METHOD, AND INKJET PRINTING SYSTEM

(71) Applicant: MIMAKI ENGINEERING CO., LTD., Nagano (JP)

(72) Inventor: MASARU OHNISHI, NAGANO (JP)

(73) Assignee: MIMAKI ENGINEERING CO., LTD., NAGANO (JP)

(21) Appl. No.: 14/901,078

(22) PCT Filed: Jun. 25, 2014
(86) PCT No.: PCT/JP2014/066893

§ 371 Date: Dec. 28, 2015

(30) Foreign Application Priority Data
Jun. 26, 2013 (JP) 2013-134276

(51) Int. Cl. B41J 11/00; B41J 2/01

(52) U.S. Cl. CPC B41J 11/002; B41J 2/01

(57) ABSTRACT

An inkjet printer, an inkjet printing method, and an inkjet printing system are provided. An ultraviolet-absorbing light shielding plate of an inkjet printer has a position in a main scanning direction shown by an arrow that is disposed between a position of a recording head in the main scanning direction shown by the arrow and a position of a light source in the main scanning direction shown by the arrow, and the light source of the ultraviolet irradiating device is disposed on a point side with respect to a line that passes through an intersection point of a perpendicular drawn from a center point of the ultraviolet-absorbing light shielding plate in the main scanning direction shown by the arrow to a medium supporting unit, and an end point of the ultraviolet-absorbing light shielding plate on the light source side in the main scanning direction shown by the arrow.

### TECHNICAL FIELD

The present invention relates to an inkjet printer provided with a recording head that discharges photocuring ink which cures by light being radiated thereon, and a light irradiating device that irradiates the photocuring ink discharged by the recording head with light.

### BACKGROUND ART

An inkjet printer that includes a recording head that discharges ultraviolet curing ink which is photocuring ink and cures by ultraviolet ray as light being radiated thereon, and an ultraviolet irradiating device as a light irradiating device that irradiates the ultraviolet curing ink discharged by the recording head with ultraviolet ray is known as a conventional inkjet printer (see Patent Document 1). The inkjet printer can suppress curing of the ultraviolet curing ink on a nozzle face by preventing the light radiated by the ultraviolet irradiating device from illuminating the nozzle face, where nozzles that discharge the ultraviolet curing ink are formed within the recording head, using a light trap, with the light being reflected on a medium supporting unit that supports a print medium on which an image is to be formed by the photocuring ink or on the print medium being supported by the medium supporting unit; by which, as a result, a generation of discharging defect of the ultraviolet curing ink in the recording head can be suppressed.

### PRIOR ART DOCUMENT

### Patent Document

Patent Document 1: JP 2005-53221 A

### SUMMARY OF THE INVENTION

### Problem to be Solved by the Invention

However, the inventor of the present application reached a conclusion that a function to prevent the light radiated by the ultraviolet irradiating device from illuminating the nozzle face of the recording head is not sufficient in the conventional inkjet printer.

Thus, the present invention aims to provide an inkjet printer, an inkjet printing method, and an inkjet printing system that can improve a function to prevent the light radiated by the light irradiating device from illuminating the nozzle face of the recording head than in the conventional technique.

### Solutions to the Problem

An inkjet printer of the present invention includes: a medium supporting unit that supports a print medium; a recording head having a nozzle face formed to face the medium supporting unit, nozzles that discharge photocuring ink toward the print medium supported on the medium supporting unit being formed on the nozzle face, the photocuring ink configured to cure by light irradiation; a light irradiating device that irradiates the photocuring ink discharged by the recording head and adhered onto the print medium with light; and a light shielding unit that shields the light radiated by the light irradiating device, wherein the light irradiating device includes a light source that radiates light, the light shielding unit has a position in an aligned direction of the recording head and the light source that is between a position of the recording head in the aligned direction and a position of the light source in the aligned direction, and the light source is disposed on a line or on a center point side with respect to the line, the line passing through an intersection point of a perpendicular drawn from a center point of the light shielding unit in the aligned direction to the medium supporting unit and an end point of the light shielding unit on a light source side in the aligned direction.

According to this configuration, the inkjet printer of the present invention can prevent light with an orientation for a component in the aligned direction of the recording head and the light source being an orientation that approaches the recording head, within the light radiated by the light irradiating device, from progressing toward a recording head side than the end point of the light shielding unit on the recording head side after it has been reflected by the medium supporting unit or the print medium supported by the medium supporting unit, by the light shielding unit, so that the light can be prevented from illuminating the nozzle face of the recording head; and as a result, the function to prevent the light radiated by the light irradiating device from illuminating the nozzle face of the recording head can be improved than in the conventional technique.

Further, in the inkjet printer of the present invention, the aligned direction may be a scanning direction of the recording head.

In the case of this configuration, the inkjet printer of the present invention has a demerit in that an entirety of the inkjet printer becomes large in the scanning direction of the recording head if a distance between the recording head and the light source is set long. However, in the inkjet printer of the present invention, since the light radiated by the light source can be prevented from illuminating the nozzle face of the recording head, the distance between the recording head and the light source can be made short, as a result of which the entirety of the inkjet printer can be made compact in the scanning direction of the recording head.

Further, in the inkjet printer of the present invention, the light irradiating device may include an opposite-side reflecting unit that is disposed on an opposite side from the recording head side with respect to the light source in the aligned direction and that reflects the light radiated by the light source, and an end of the opposite-side reflecting unit on a medium supporting unit side may be disposed on the line or on the center point side with respect to the line.

According to this configuration, the inkjet printer of the present invention can prevent light with the orientation for the component in the aligned direction of the recording head and the light source being an orientation that separates away from the recording head, within the light radiated by the light irradiating device, from progressing toward the recording head side than the end point of the light shielding unit on the recording head side after it has been reflected by the medium supporting unit or the print medium supported by the medium supporting unit, by the light shielding unit, so that the light can be prevented from illuminating the nozzle face of the recording head.

Further, in the inkjet printer of the present invention, the light irradiating device may include an opposite-side reflecting unit that is disposed on an opposite side from the recording head side with respect to the light source in the aligned direction and that reflects the light radiated by the light source, and the opposite-side reflecting unit may be disposed in a state of vertically intersecting the line, or in a state of being tilted in a direction by which the opposite-side reflecting unit is tilted with respect to the medium supporting unit.

According to this configuration, the inkjet printer of the present invention can prevent light with the orientation for the component in the aligned direction of the recording head and the light source being an orientation that separates away from the recording head, within the light radiated by the light irradiating device, from progressing toward the recording head side than the end point of the light shielding unit on the recording head side after it has been reflected by the opposite-side reflecting unit and further reflected by the medium supporting unit or the print medium supported by the medium supporting unit, by the light shielding unit, so that the light can be prevented from illuminating the nozzle face of the recording head.

An inkjet printing method of the present invention is an inkjet printing method using an inkjet printer that includes a medium supporting unit that supports a print medium; a recording head having a nozzle face formed to face the medium supporting unit, nozzles that discharge photocuring ink toward the print medium supported on the medium supporting unit being foiiiied on the nozzle face, the photocuring ink configured to cure by light irradiation; and a light irradiating device that irradiates the photocuring ink discharged by the recording head and adhered onto the print medium with light, the method including: performing discharge of the photocuring ink by the recording head onto the print medium and light irradiation by the light irradiating device onto the photocuring ink adhered to the print medium in a state where a light shielding wall that shields light is disposed to surround a periphery of the print medium supported by the medium supporting unit.

According to this configuration, the inkjet printing method of the present invention can prevent the light radiated by the light irradiating device from illuminating the nozzle face of the recording head by the light shielding wall after the light has been reflected by the print medium, so that the function to prevent the light radiated by the light irradiating device from illuminating the nozzle face of the recording head can be improved than in the conventional technique. Further, the inkjet printing method of the present invention can further suppress a generation of wind that may cause changes in a progressing direction of the photocuring ink discharged by the recording head, so that print quality can be improved.

An inkjet printing system of the present invention includes: a medium supporting unit that supports a print medium; a recording head having a nozzle face formed to face the medium supporting unit, nozzles that discharge photocuring ink toward the print medium supported on the medium supporting unit being formed on the nozzle face, the photocuring ink configured to cure by light irradiation; a light irradiating device that moves together with the recording head in a scanning direction of the recording head and irradiates the photocuring ink discharged by the recording head with light; and a moving range controlling unit that controls a moving range of the recording head in the scanning direction, wherein the moving range controlling unit decreases the moving range in accordance with an increase in a gap along the scanning direction between the recording head and the light irradiating device.

According to this configuration, the inkjet printing system of the present invention can prevent light with the orientation for a component in the scanning direction being the orientation that approaches the recording head, within the light radiated by the light irradiating device, from illuminating the nozzle face of the recording head after it has been reflected by the medium supporting unit or the print medium supported by the medium supporting unit, by the increase in the gap of the recording head and the light irradiating device in the scanning direction, so that the function to prevent the light radiated by the light irradiating device from illuminating the nozzle face of the recording head can be improved than in the conventional technique. Further, the inkjet printing system of the present invention automatically decreases the moving range of the recording head in the scanning direction in accordance with the increase in the gap of the recording head and the light irradiating device in the scanning direction, whereby convenience can be improved.

An inkjet printer of the present invention includes: a medium supporting unit that supports a print medium; a recording head having a nozzle face formed to face the medium supporting unit, nozzles that discharge photocuring ink toward the print medium supported on the medium supporting unit being formed on the nozzle face, the photocuring ink configured to cure by light irradiation; a light irradiating device that moves together with the recording head in a scanning direction of the recording head and irradiates the photocuring ink discharged by the recording head with light; a bias supporting unit that supports the recording head and the light irradiating device while biasing in a direction along which a gap between the recording head and the light irradiating device in the scanning direction increases; and a movement restricting unit that is disposed at an end of a moving range of the light irradiating device in the scanning direction and restricts a movement of the light irradiating device in the scanning direction by making contact with the light irradiating device.

According to this configuration, the inkjet printer of the present invention can prevent light with the orientation for the component in the aligned direction of the recording head and the light irradiating device being the orientation that approaches the recording head, within the light radiated by the light irradiating device, from illuminating the nozzle face of the recording head after it has been reflected by the medium supporting unit or the print medium supported by the medium supporting unit, by the increase in the gap of the recording head and the light irradiating device in the scanning direction at the time when the photocuring ink adhered onto the print medium is irradiated with light by the light irradiating device, as a result of which the function to prevent the light radiated by the light irradiating device from illuminating the nozzle face of the recording head can be improved than in the conventional technique. Further, in the inkjet printer of the present invention, the gap of the recording head and the light irradiating device in the scanning direction can be reduced by the movement restricting unit making contact with the light irradiating device at the end of the moving range of the light irradiating device in the scanning direction, so that even if the gap of the recording head and the light irradiating device in the scanning direction at the time when the photocuring ink adhered onto the print medium is irradiated with light by the light irradiating device is provided sufficiently, the moving range of the recording head in the scanning direction can be prevented from being reduced.

Further, in the inkjet printer of the present invention, the light irradiating device may stop the light irradiation when the movement is restricted by the movement restricting unit.

According to this configuration, the inkjet printer of the present invention can prevent the light radiated by the light irradiating device from illuminating the nozzle face of the recording head after it has been reflected by the medium supporting unit or the print medium supported by the medium supporting unit at the end of the moving range of the light irradiating device in the scanning direction, since the light irradiation by the light irradiating device is automatically stopped when the gap of the recording head and the light irradiating device in the scanning direction is reduced at the end of the moving range of the light irradiating device in the scanning direction.

### Effects of the Invention

The inkjet printer, the inkjet printing method, and the inkjet printing system of the present invention can improve the function to prevent the light radiated by the light irradiating device from illuminating the nozzle face of the recording head than in the conventional technique.

### BRIEF DESCRIPTION OF THE DRAWINGS

FIG. 1 is a perspective view of an inkjet printer according to a first embodiment of the present invention.

FIG. 2 is a front view of a vicinity of an ultraviolet irradiating device shown in FIG. 1.

FIG. 3A is a side view of the ultraviolet irradiating device shown in FIG. 1; and FIG. 3B is a bottom view of the ultraviolet irradiating device shown in FIG. 1.

FIG. 4 is a front view of a vicinity of the ultraviolet irradiating device shown in FIG. 1 for explaining a positional relationship of a light source and a reflection plate.

FIG. 5 is a front view of the vicinity of the ultraviolet irradiating device in a state where the ultraviolet irradiating device shown in FIG. 1 is tilted.

FIG. 6 is a front view of a vicinity of an ultraviolet irradiating device of an inkjet printer according to a second embodiment of the present invention.

FIG. 7 is a front view of the vicinity of the ultraviolet irradiating device shown in FIG. 6 for explaining a positional relationship of a light source and a reflection plate.

FIG. 8 is a front view of the vicinity of the ultraviolet irradiating device shown in FIG. 6 in a state where the reflection plate is tilted by 45° with respect to a perpendicular of a medium supporting face in a direction of being tilted with respect to the medium supporting unit from a state where the reflection plate vertically intersects the medium supporting face.

FIG. 9 is a front view of a vicinity of an ultraviolet irradiating device of an inkjet printer according to a third embodiment of the present invention.

FIG. 10 is a plan view of a vicinity of a light shielding wall shown in FIG. 9.

FIG. 11 is a block diagram of an inkjet printing system according to a fourth embodiment of the present invention.

FIG. 12 is a block diagram of a computer shown in FIG. 11.

FIG. 13 is a block diagram of an inkjet printer shown in FIG. 11.

FIG. 14 is a flowchart of an operation by the computer shown in FIG. 12 in a case of changing a gap between a recording head and an ultraviolet irradiating device in a main scanning direction.

FIG. 15 is an upper face sectional view of a vicinity of a carriage of an inkjet printer according to a fifth embodiment of the present invention.

FIG. 16A is an upper face sectional view of the vicinity of the carriage shown in FIG. 15 at one end side in a main scanning direction of the inkjet printer; and FIG. 16B is an upper face sectional view of the vicinity of the carriage shown in FIG. 15 at the other end side in the main scanning direction of the inkjet printer.

### EMBODIMENTS OF THE INVENTION

Embodiments of the present invention will be described hereinbelow with reference to the drawings.

### First Embodiment

Firstly, a configuration of an inkjet printer according to a first embodiment of the present invention will be described.

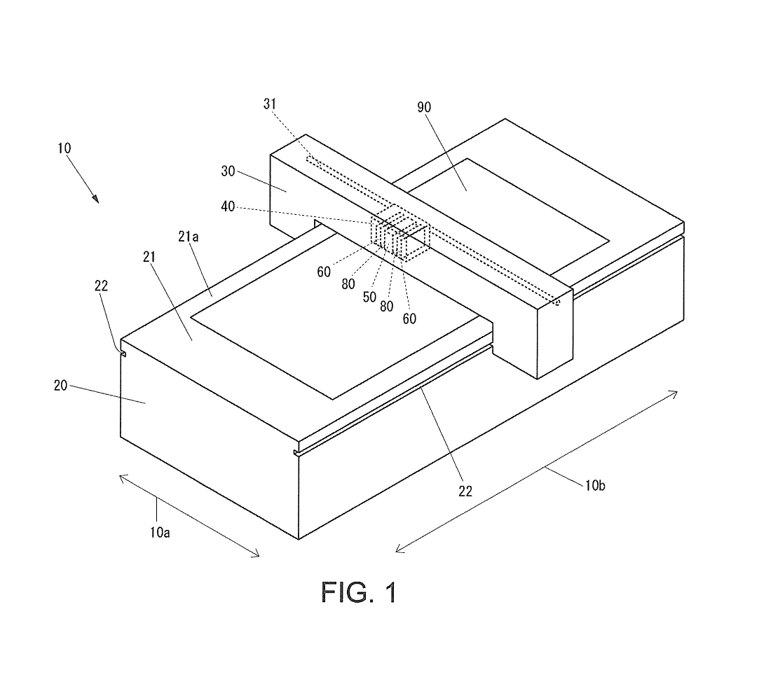

FIG. 1 is a perspective view of an inkjet printer 10 of the present embodiment.

As shown in FIG. 1, an inkjet printer 10 includes a table 20 that supports a print medium 90, and a Y bar 30 extending in a scanning direction shown by an arrow 10a (hereafter referred to as a “main scanning direction”). The inkjet printer 10 is a device that applies ultraviolet curing ink automatically in a shape based on inputted data.

The table 20 includes a medium supporting unit 21 that supports the print medium 90 such as paper. The medium supporting unit 21 has a medium supporting face 21a for supporting the print medium 90 formed thereon. A color of the medium supporting face 21a is a color that can absorb ultraviolet ray, such as black. For example, the medium supporting unit 21 is formed of metal such as aluminum, and at least has a carbon coating by an ultraviolet-absorbing paint, or a black coating by an ultraviolet-absorbing dye performed on the medium supporting face 21a.

Further, the table 20 includes guiding mechanisms 22 that extend in a scanning direction shown by an arrow 10b (hereafter referred to as a “sub scanning direction”) that vertically intersects the main scanning direction shown by the arrow 10a and support the Y bar 30 so as to be movable in the sub scanning direction shown by the arrow 10b on both sides in the main scanning direction shown by the arrow 10a.

The Y bar 30 includes a guide rail 31 extending in the main scanning direction shown by the arrow 10a, and a carriage 40 supported on the guide rail 31 so as to be movable in the main scanning direction shown by the arrow 10a.

The carriage 40 includes a recording head 50 that discharges droplets of the ultraviolet curing ink being photocuring ink that cures by ultraviolet ray as light being radiated, ultraviolet irradiating devices 60 as light irradiating devices that irradiate the ultraviolet curing ink discharged by the recording head 50 with ultraviolet ray, and ultraviolet-absorbing light shielding plates 80 as light shielding units that shield the ultraviolet ray radiated by the ultraviolet irradiating devices 60.

The recording head 50 is a device that discharges the droplets of the ultraviolet curing ink toward the print medium 90 supported by the table 20.

The ultraviolet irradiating devices 60 are devices that irradiate the ultraviolet curing ink discharged from the recording head 50 and adhered onto the print medium 90 with ultraviolet ray. The ultraviolet irradiating devices 60 are provided one each on both sides of the recording head 50 in the main scanning direction shown by the arrow 10a.

The ultraviolet-absorbing light shielding plates 80 are provided one each on both sides of the recording head 50 in the main scanning direction shown by the arrow 10a. A color of the ultraviolet-absorbing light shielding plates 80 is a color that can absorb the ultraviolet ray, such as black. For example, the ultraviolet-absorbing light shielding plates 80 are formed of metal such as aluminum, and at least have a carbon coating by an ultraviolet-absorbing paint, or a black coating by an ultraviolet-absorbing dye performed on surfaces thereof.

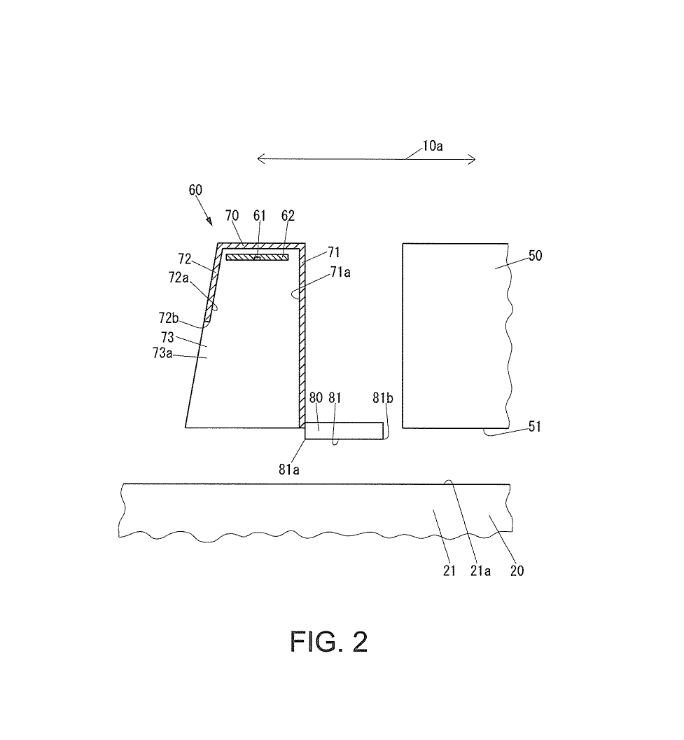

FIG. 2 is a front view of a vicinity of an ultraviolet irradiating device 60.

It should be noted that FIG. 2 only shows the ultraviolet irradiating device 60 on a left side as seen from a front side of the inkjet printer 10, of the two ultraviolet irradiating devices 60 of the inkjet printer 10 (see FIG. 1). Further, FIG. 2 omits a part of the configuration, such as the carriage 40 (see FIG. 1). In FIG. 2, the ultraviolet irradiating device 60 is shown in its cross section.

As shown in FIG. 2, the recording head 50 includes a nozzle face 51 in which nozzles that are not shown for discharging the ultraviolet curing ink are formed. The nozzle face 51 is a surface parallel to the medium supporting face 21a of the table 20. The nozzle face 51 has a plurality of rows of nozzles extending in the sub scanning direction shown by the arrow 10b (see FIG. 1) (hereafter referred to as “nozzle rows”) provided thereon. The nozzle rows are provided for each type of the ultraviolet curing ink, for example, the ultraviolet curing ink in cyan, the ultraviolet curing ink in magenta, the ultraviolet curing ink in yellow, the ultraviolet curing ink in black, the ultraviolet curing ink in white, the ultraviolet curing ink that is transparent, and the like.

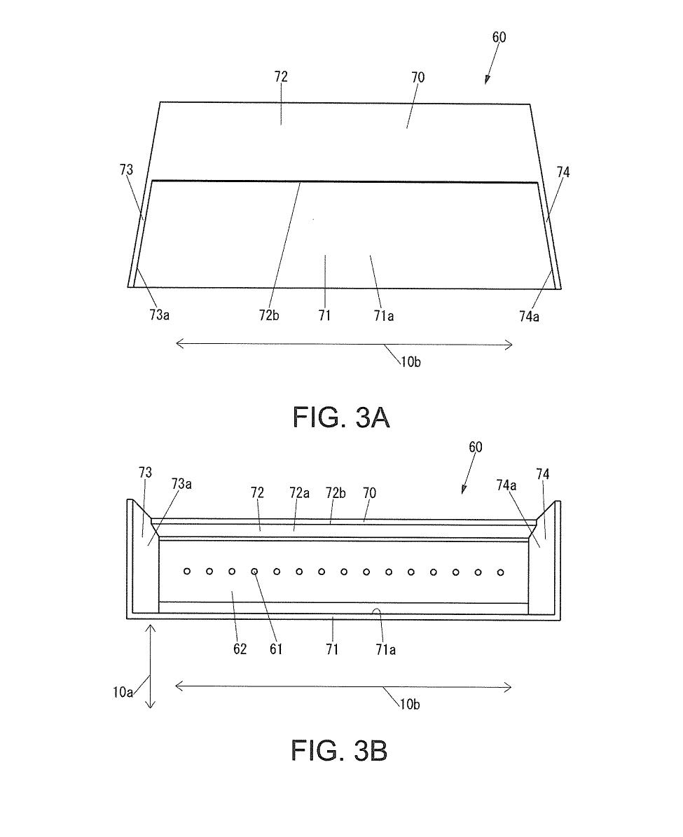

FIG. 3A is a side view of the ultraviolet irradiating device 60. FIG. 3B is a bottom view of the ultraviolet irradiating device 60.

As shown in FIG. 2, FIG. 3A, and FIG. 3B, the ultraviolet irradiating device 60 includes light sources 61 that radiate the ultraviolet ray, a light source supporting unit 62 that supports the light sources 61, and a lamp housing 70 that surrounds the light sources 61 so as to collect the ultraviolet ray radiated by the light sources 61 and effectively radiates the same toward the medium supporting unit 21 of the table 20.

A plurality of the light sources 61 are aligned in the sub scanning direction shown by the arrow 10b. As the light sources 61, any arbitrary configuration may be used, such as LDs (Laser Diodes), LEDs (Light Emitting Diodes), and metal halide lamps.

Positions of the ultraviolet-absorbing light shielding plates 80 in an aligned direction of the recording head 50 and the light sources 61, that is, in the main scanning direction shown by the arrow 10a are disposed between a position of the recording head 50 in the main scanning direction shown by the arrow 10a and a position of the light sources 61 in the main scanning direction shown by the arrow 10a.

The lamp housing 70 includes a reflection plate 71 that is disposed on a recording head 50 side with respect to the light sources 61 and reflects the ultraviolet ray radiated by the light sources 61, a reflection plate 72 as an opposite-side reflecting unit that is disposed on an opposite side of the recording head 50 side with respect to the light sources 61 and reflects the ultraviolet ray radiated by the light sources 61, and two reflection plates 73, 74 that are disposed at positions to sandwich the light sources 61 in the sub scanning direction shown by the arrow 10b and reflect the ultraviolet ray radiated by the light sources 61.

A color of an inside of the lamp housing 70 is metallic or white. That is, the reflection plates 71, 72, 73, 74 respectively have reflection surfaces 71a, 72a, 73a, 74a formed on the light sources 61 side.

A color of an outside of the lamp housing 70 is a color that can absorb the ultraviolet ray, such as black. For example, the lamp housing 70 may have a carbon coating by an ultraviolet-absorbing paint, or a black coating by an ultraviolet-absorbing dye performed on its outer surface.

The reflection plate 71 preferably vertically intersects the main scanning direction shown by the arrow 10a, that is, vertically intersects the medium supporting face 21a.

The reflection plate 73 is preferably disposed in a state of being tilted relative to a state of vertically intersecting the medium supporting face 21a, that is, in a state of being tilted in a direction of being tilted with respect to the medium supporting unit 21 than in the state of vertically intersecting the medium supporting face 21a.

Similarly, the reflection plate 74 is preferably disposed in the state of being tilted relative to the state of vertically intersecting the medium supporting face 21a, that is, in the state of being tilted in a direction of being tilted with respect to the medium supporting unit 21 than in the state of vertically intersecting the medium supporting face 21a.

It should be noted that light amount of the ultraviolet ray radiated by the light sources 61 is in inverse proportion to the square of the distance from the light sources 61. Thus, as a countermeasure for a case where the ultraviolet ray radiated by the light sources 61 reaches the nozzle face 51 of the recording head 50 while being reflected at some locations, it is preferable to set the recording head 50 and the ultraviolet irradiating devices 60 apart as much as possible in the main scanning direction shown by the arrow 10a so as to make the light amount of the ultraviolet ray reaching the nozzle face 51 of the recording head 50 small.

However, since print quality will be degraded if the ultraviolet curing ink discharged from the recording head 50 and adhered onto the print medium 90 smears on the print medium 90, so it is preferable to have an upper limit set to the distance between the recording head 50 and the ultraviolet irradiating devices 60 in the main scanning direction shown by the arrow 10a such that the ultraviolet curing ink can be cured by the ultraviolet ray from the light sources 61 before it smears on the print medium 90 after having been adhered onto the print medium 90. This upper limit is determined by considering a distance that is obtained by multiplying time since when the ultraviolet curing ink adheres onto the print medium 90 until when it smears on the print medium 90 by moving speeds of the recording head 50 and the ultraviolet irradiating devices 60 in the main scanning direction shown by the arrow 10a, that is, the moving speed of the carriage 40 (see FIG. 1) in the main scanning direction shown by the arrow 10a. The time since when the ultraviolet curing ink adheres onto the print medium 90 until when it smears on the print medium 90 is for example 0.2 second, though depending on types of the ultraviolet curing ink.

A distance between a surface 81 on a side of the medium supporting face 21a of the table 20, of each ultraviolet-absorbing light shielding plate 80 and the medium supporting face 21a of the table 20 is equal to or less than the distance between the nozzle face 51 of the recording head 50 and the medium supporting face 21a of the table 20.

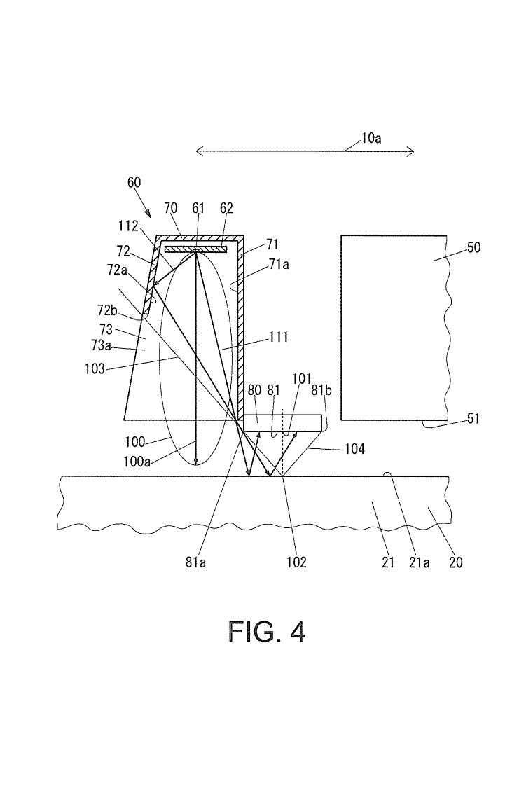

FIG. 4 is a front view of the vicinity of the ultraviolet irradiating device 60 for explaining a positional relationship of a light source 61 and a reflection plate 72.

In FIG. 4, a curve 100 shows a directional curve of the light source 61 for a case where the light source 61 is a UV-LED.

A point 101 shows a center point of the ultraviolet-absorbing light shielding plate 80 in the main scanning direction shown by the arrow 10a. A point 102 shows an intersection point of a perpendicular drawn from the point 101 to the medium supporting unit 21.

A line 103 shows a line that passes through the point 102 and an end point 81a of the surface 81 of the ultraviolet-absorbing light shielding plate 80 on the light source 61 side in the main scanning direction shown by the arrow 10a, when the distance between the surface 81 of the ultraviolet-absorbing light shielding plate 80 and the medium supporting face 21a of the table 20 is changeable, and the distance between the surface 81 of the ultraviolet-absorbing light shielding plate 80 and the medium supporting face 21a of the table 20 is at a possible maximum distance in a state where the inkjet printer 10 (see FIG. 1) is performing printing.

A line 104 shows a line that passes through the point 102 and an end point 81b of the surface 81 of the ultraviolet-absorbing light shielding plate 80 on the recording head 50 side in the main scanning direction shown by the arrow 10a, when the distance between the surface 81 of the ultraviolet-absorbing light shielding plate 80 and the medium supporting face 21a of the table 20 is changeable, and the distance between the surface 81 of the ultraviolet-absorbing light shielding plate 80 and the medium supporting face 21a of the table 20 is at a possible maximum distance in the state where the inkjet printer 10 is performing printing.

As shown in FIG. 4, the light source 61 is disposed on the point 101 side with respect to the line 103.

An end 72b of the reflection plate 72 on the medium supporting unit 21 side is disposed on the point 101 side with respect to the line 103.

Next, an operation of the inkjet printer 10 will be described.

The inkjet printer 10 executes printing based on print data when the print data sent from the outside is received.

Specifically, the inkjet printer 10 moves the recording head 50 and the ultraviolet irradiating devices 60 mounted on the carriage 40 in the main scanning direction shown by the arrow 10a with respect to the print medium 90 supported on the table 20 by moving the carriage 40 along the guide rails 31 in the main scanning direction shown by the arrow 10a with respect to the Y bar 30 supported by the table 20. At this occasion, the inkjet printer 10 discharges the ultraviolet curing ink by the recording head 50 toward the print medium 90 supported on the table 20, and thereafter performs printing in the main scanning direction shown by the arrow 10a by irradiating the ultraviolet curing ink discharged by the recording head 50 and adhered onto the print medium 90 with ultraviolet ray by the ultraviolet irradiating devices 60. It should be noted that in a case of performing print with the carriage 40 moving in the right side in FIG. 1 along the main scanning direction shown by the arrow 10a, the inkjet printer 10 radiates the ultraviolet ray by the ultraviolet irradiating device 60 disposed on the left side in FIG. 1 with respect to the recording head 50, and in a case of performing printing with the carriage 40 moving to the left side in FIG. 1 along the main scanning direction shown by the arrow 10a, it radiates the ultraviolet ray by the ultraviolet irradiating device 60 disposed on the right side in FIG. 1 with respect to the recording head 50.

Further, each time the printing in the main scanning direction shown by the arrow 10a is completed at a predetermined position in the sub scanning direction shown by the arrow 10b, the inkjet printer 10 moves the recording head 50 and the ultraviolet irradiating devices 60 mounted on the carriage 40 supported on the Y bar 30 in the sub scanning direction shown by the arrow 10b with respect to the print medium 90 supported on the table 20 by moving the Y bar 30 along the guiding mechanisms 22 in the sub scanning direction shown by the arrow 10b with respect to the table 20, and performs the printing in the main scanning direction shown by the arrow 10a again at a subsequent position in the sub scanning direction shown by the arrow 10b.

It should be noted that as shown in FIG. 4, since the light sources 61 are disposed on the point 101 side with respect to the line 103, ultraviolet ray 111 within the ultraviolet ray radiated by the light sources 61 having an orientation for a component in the main scanning direction shown by the arrow 10a being an orientation that approaches the recording head 50 is reflected by the medium supporting unit 21 or the print medium 90 supported on the medium supporting unit 21, and is always absorbed by illuminating the ultraviolet-absorbing light shielding plates 80 even if it progresses between the surface 81 of the ultraviolet-absorbing light shielding plate 80 and the medium supporting face 21a of the table 20.

Further, since the end 72b of the reflection plate 72 on the medium supporting unit 21 side is disposed on the point 101 side with respect to the line 103, ultraviolet ray 112 within the ultraviolet ray radiated by the light sources 61 having an orientation for a component in the main scanning direction shown by the arrow 10a being an orientation that separates away from the recording head 50 is reflected by the reflection plate 72, and thereafter further reflected by the medium supporting unit 21 or the print medium 90 supported on the medium supporting unit 21, and is always absorbed by illuminating the ultraviolet-absorbing light shielding plates 80 even if it progresses between the surface 81 of the ultraviolet-absorbing light shielding plate 80 and the medium supporting face 21a of the table 20.

As described above, the inkjet printer 10 can prevent the ultraviolet ray 111 within the ultraviolet ray radiated by the light sources 61 having the orientation for the component in the main scanning direction shown by the arrow 10a being the orientation that approaches the recording head 50 from progressing toward the recording head 50 side than the end point 81b of the ultraviolet-absorbing light shielding plate 80 on the recording head 50 side after having been reflected by the medium supporting unit 21 or the print medium 90 supported on the medium supporting unit 21, by the ultraviolet-absorbing light shielding plate 80, so that the ultraviolet ray can be prevented from illuminating the nozzle face 51 of the recording head 50, as a result of which a function to prevent the ultraviolet ray from illuminating the nozzle face 51 of the recording head 50 can be improved than in a conventional technique.

It should be noted that the inkjet printer 10 has the light source 61 disposed on the point 101 side with respect to the line 103 in the present embodiment. However, the inkjet printer 10 can achieve similar effects with the light source 61 being disposed on the line 103.

The inkjet printer 10 has a demerit in that an entirety of the inkjet printer 10 becomes large in the main scanning direction shown by the arrow 10a if the distance between the recording head 50 and the light sources 61 is set long, since the aligned direction of the recording head 50 and the light sources 61 is the main scanning direction shown by the arrow 10a of the recording head 50. However, in the inkjet printer 10, since the light radiated by the light sources 61 can be prevented from illuminating the nozzle face 51 of the recording head 50 by the ultraviolet-absorbing light shielding plate 80, the distance between the recording head 50 and the light sources 61 can be made short, as a result of which the entirety of the inkjet printer 10 can be made compact in the main scanning direction shown by the arrow 10a.

The inkjet printer 10 can prevent the ultraviolet ray 112 within the ultraviolet ray radiated by the light sources 61 having the orientation for the component in the main scanning direction shown by the arrow 10a being the orientation that separates away from the recording head 50 from progressing toward the recording head 50 side than the end point 81b of the ultraviolet-absorbing light shielding plate 80 on the recording head 50 side after having been reflected by the reflection plate 72 and further reflected by the medium supporting unit 21 or the print medium 90 supported on the medium supporting unit 21, by the ultraviolet-absorbing light shielding plate 80, so that the ultraviolet ray can be prevented from illuminating the nozzle face 51 of the recording head 50.

It should be noted that the inkjet printer 10 has the end 72b of the reflection plate 72 on the medium supporting unit 21 side disposed on the point 101 side with respect to the line 103 in the present embodiment. However, the inkjet printer 10 can achieve similar effects even with the end 72b of the reflection plate 72 on the medium supporting unit 21 side being disposed on the line 103.

In case where the reflection plate 71 and the reflection plate 72 facing each other in the ultraviolet irradiating devices 60 are parallel, the inkjet printer 10 has a problem that the ultraviolet ray radiated in a direction substantially parallel to the medium supporting face 21a by the light sources 61 progresses in the direction substantially parallel to the medium supporting face 21a after having been reflected plural times by the reflection plate 71 and the reflection plate 72, and is reflected by the medium supporting unit 21 or the print medium 90 supported by the medium supporting unit 21, as a result of which there is a possibility of illuminating the nozzle face 51 of the recording head 50. However, in the inkjet printer 10 in the present embodiment, the reflection plate 71 and the reflection plate 72 are not parallel, so that the occurrence of such a problem can be suppressed.

Further, in the inkjet printer 10, the reflection plate 73 and the reflection plate 74 facing each other in the ultraviolet irradiating devices 60 are also not parallel, so that the occurrence of a similar problem can be suppressed also for the reflection plate 73 and the reflection plate 74.

It should be noted that the inkjet printer 10 has the end 72b of the reflection plate 72 on the medium supporting unit 21 side disposed on the point 101 side with respect to the line 103, and can prevent the ultraviolet ray radiated by the light sources 61 from being reflected by the reflection plate 72 and illuminating the nozzle face 51 of the recording head 50 by the ultraviolet-absorbing light shielding plates 80, so that the reflection plate 71 and the reflection plate 72 facing each other in the ultraviolet irradiating devices 60 may be parallel.

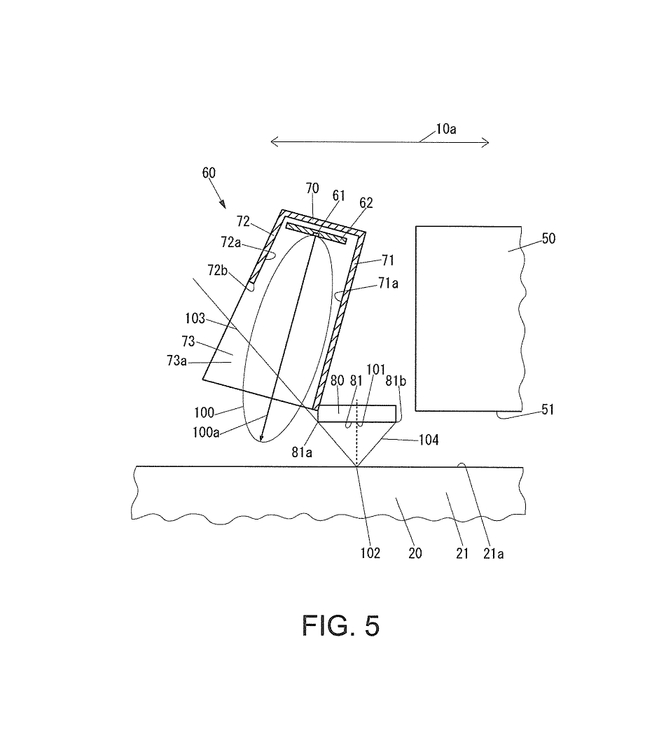

Further, as shown in FIG. 4, the inkjet printer 10 in the present embodiment has a center line 100a of the directivity of the light source 61 intersect vertically to the medium supporting face 21a of the table 20. However, as shown in FIG. 5, the inkjet printer 10 may be disposed in a state where the ultraviolet irradiating device 60 is tilted than a state where the center line 100a of the directivity of the light source 61 intersects vertically to the medium supporting face 21a of the table 20, that is, in a state where an upper portion of the ultraviolet irradiating device 60 approaches the recording head 50 than in the state where the center line 100a of the directivity of the light source 61 intersects vertically to the medium supporting face 21a of the table 20. Even when the ultraviolet irradiating device 60 is in the tilted state as shown in FIG. 5, the inkjet printer 10 can achieve similar effect as in the state shown in FIG. 4, if the end 72b of the reflection plate 72 on the medium supporting unit 21 side is disposed on the point 101 side with respect to the line 103, or on the line 103. Further, the inkjet printer 10 can improve the function to prevent the ultraviolet ray radiated from the ultraviolet irradiating devices 60 from illuminating the nozzle face 51 of the recording head 50 as compared to the state shown in FIG. 4, if the ultraviolet irradiating devices 60 are in the tilted state as shown in FIG. 5.

In the inkjet printer 10, in the present embodiment, the recoding head 50 is moved relatively in the sub scanning direction shown by the arrow 10b with respect to the print medium 90 by moving the recoding head 50 in the sub scanning direction shown by the arrow 10b; however, it may have a configuration other than the above configuration. For example, the inkjet printer 10 may be configured to relatively move the recording head 50 in the sub scanning direction shown by the arrow 10b with respect to the print medium 90 by conveying the print medium 90 in the sub scanning direction shown by the arrow 10b.

### Second Embodiment

Firstly, a configuration of an inkjet printer according to a second embodiment of the present invention will be described.

It should be noted that among the components of the inkjet printer of the present embodiment, components identical to the components of the inkjet printer 10 of the first embodiment (see FIG. 1) will be given the same reference signs as the inkjet printer 10, and the detailed description thereof will be omitted.

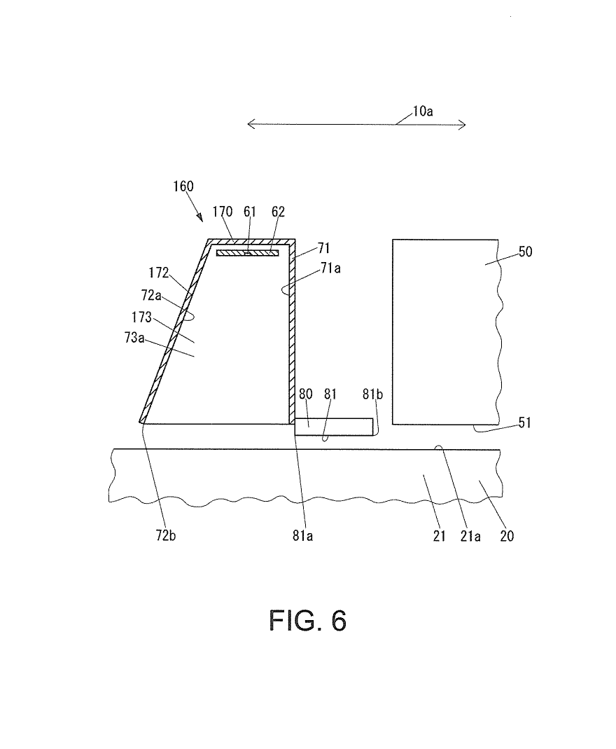

FIG. 6 is a front view of a vicinity of an ultraviolet irradiating device 160 of the inkjet printer according to the present embodiment.

It should be noted that FIG. 6 only shows the ultraviolet irradiating device 160 on a left side as seen from a front side of the inkjet printer, of the two ultraviolet irradiating devices 160 of the inkjet printer according to the present embodiment. Further, FIG. 6 omits a part of the configuration, such as the carriage 40 (see FIG. 1). In FIG. 6, the ultraviolet irradiating devices 160 are shown in their cross section.

As shown in FIG. 6, the configuration of the inkjet printer according to the present embodiment is similar to a configuration in which the inkjet printer 10 (see FIG. 1) has the ultraviolet irradiating devices 160 as the light irradiating devices that irradiate ultraviolet curing ink discharged by a recording head 50 with ultraviolet ray instead of the ultraviolet irradiating devices 60 (see FIG. 2), and in which the recording head 50 and ultraviolet-absorbing light shielding plates 80 approach a medium supporting face 21a of a table 20 as compared to the inkjet printer 10.

The ultraviolet irradiating device 160 has a similar configuration in which the ultraviolet irradiating device 60 includes a lamp housing 170 instead of the lamp housing 70 (see FIG. 2), and it is closer to the medium supporting face 21a of the table 20 compared to the ultraviolet irradiating devices 60.

The lamp housing 170 has a similar configuration in which the lamp housing 70 includes a reflection plate 172 as an opposite-side reflecting unit that is disposed on an opposite side from the recording head 50 side with respect to the light source 61 and reflects the ultraviolet ray radiated by the light sources 61, a reflection plate 173 that is disposed at a position in a sub scanning direction shown by an arrow 10b (see FIG. 1) with respect to the light source 61 and reflects the ultraviolet ray radiated by the light sources 61, and a reflection plate that is not shown, disposed at a position to sandwich the light source 61 with the reflection plate 173 in the sub scanning direction shown by the arrow 10b, and reflects the ultraviolet ray radiated by the light sources 61, instead of the reflection plate 72 (see FIG. 2), the reflection plate 73 (see FIG. 2), and the reflection plate 74 (see FIG. 2).

The reflection plate 172 has a similar configuration in which the reflection plate 72 changed its length and angle with respect to the medium supporting face 21a of the table 20.

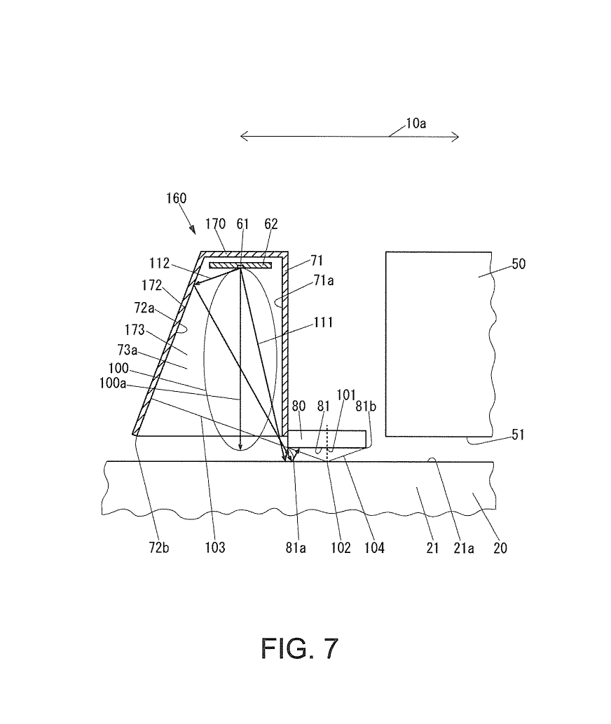

FIG. 7 is a front view of the vicinity of the ultraviolet irradiating device 160 for explaining a positional relationship of a light source 61 and a reflection plate 172.

As shown in FIG. 7, the reflection plate 172 is disposed in a state of being tilted in a direction of being tilted with respect to the medium supporting unit 21 than in a state of vertically intersecting a line 103.

The reflection plate 173 and a reflection plate that is not shown and facing the reflection plate 173 extend in the main scanning direction shown by the arrow 10a so as to connect the reflection plate 71 and the reflection plate 172 such that the ultraviolet ray radiated by the light sources 61 can be prevented from leaking out in the sub scanning direction shown by the arrow 10b.

Next, an operation of the inkjet printer according to the present embodiment will be described.

The inkjet printer according to the present embodiment can perform printing similar to the inkjet printer 10 (see FIG. 1) according to the first embodiment.

It should be noted that as shown in FIG. 7, since the light sources 61 are disposed on the point 101 side with respect to the line 103, ultraviolet ray 111 within the ultraviolet ray radiated by the light sources 61 having an orientation for a component in the main scanning direction shown by the arrow 10a being an orientation that approaches the recording head 50 is reflected by the medium supporting unit 21 or the print medium 90 supported on the medium supporting unit 21, and is always absorbed by illuminating the ultraviolet-absorbing light shielding plates 80 even if it progresses between the surface 81 of the ultraviolet-absorbing light shielding plate 80 and the medium supporting face 21a of the table 20.

Further, since the reflection plate 172 is disposed in the state of being tilted in the direction of being tilted with respect to the medium supporting unit 21 than in the state of vertically intersecting the line 103, ultraviolet ray 112 within the ultraviolet ray radiated by the light sources 61 having an orientation for a component in the main scanning direction shown by the arrow 10a being an orientation that separates away from the recording head 50 is reflected by the reflection plate 172, and further reflected by the medium supporting unit 21 or the print medium 90 supported on the medium supporting unit 21, and is absorbed by illuminating the ultraviolet-absorbing light shielding plates 80 even if it progresses between the surface 81 of the ultraviolet-absorbing light shielding plate 80 and the medium supporting face 21a of the table 20.

As described above, the inkjet printer according to the present embodiment can prevent the ultraviolet ray 111 within the ultraviolet ray radiated by the light sources 61 having the orientation for the component in the main scanning direction shown by the arrow 10a being the orientation that approaches the recording head 50 from progressing toward the recording head 50 side than the end point 81b of the ultraviolet-absorbing light shielding plate 80 on the recording head 50 side after having been reflected by the medium supporting unit 21 or the print medium 90 supported on the medium supporting unit 21, by the ultraviolet-absorbing light shielding plate 80, so that the ultraviolet ray can be prevented from illuminating the nozzle face 51 of the recording head 50, as a result of which a function to prevent the ultraviolet ray radiated by the ultraviolet irradiating device 160 from illuminating the nozzle face 51 of the recording head 50 can be improved than in the conventional technique.

It should be noted that the inkjet printer according to the present embodiment has the light source 61 disposed on the point 101 side with respect to the line 103 in the present embodiment. However, the inkjet printer according to the present embodiment can achieve similar effects even with the light source 61 being disposed on the line 103.

The inkjet printer according to the present embodiment has a demerit in that an entirety of the inkjet printer becomes large in the main scanning direction shown by the arrow 10a if the distance between the recording head 50 and the light sources 61 is set long, since the aligned direction of the recording head 50 and the light sources 61 is the main scanning direction shown by the arrow 10a of the recording head 50. However, in the inkjet printer according to the present embodiment, since the light radiated by the light sources 61 can be prevented from illuminating the nozzle face 51 of the recording head 50 by the ultraviolet-absorbing light shielding plate 80, the distance between the recording head 50 and the light sources 61 can be made short, as a result of which the entirety of the inkjet printer can be made compact in the main scanning direction shown by the arrow 10a.

The inkjet printer according to the present embodiment can prevent the ultraviolet ray 112 within the ultraviolet ray radiated by the light sources 61 having the orientation for the component in the main scanning direction shown by the arrow 10a being the orientation that separates away from the recording head 50 from progressing toward the recording head 50 side than the end point 81b of the ultraviolet-absorbing light shielding plate 80 on the recording head 50 side after having been reflected by the reflection plate 172 and further reflected by the medium supporting unit 21 or the print medium 90 supported on the medium supporting unit 21, by the ultraviolet-absorbing light shielding plate 80, so that the ultraviolet ray can be prevented from illuminating the nozzle face 51 of the recording head 50.

It should be noted that the inkjet printer according to the present embodiment has the reflection plate 172 disposed in a state of being tilted in a direction of being tilted with respect to the medium supporting unit 21 than in a state where the reflection plate 172 vertically intersects the line 103. However, the inkjet printer 10 can achieve similar effects even with the reflection plate 172 being disposed in the state of vertically intersecting the line 103.

In case where the reflection plate 71 and the reflection plate 172 facing each other in the ultraviolet irradiating devices 160 are parallel, the inkjet printer according to the present embodiment has a problem that the ultraviolet ray radiated in a direction substantially parallel to the medium supporting face 21a by the light sources 61 progresses in the direction substantially parallel to the medium supporting face 21a after having been reflected plural times by the reflection plate 71 and the reflection plate 172, and is reflected by the medium supporting unit 21 or the print medium 90 supported by the medium supporting unit 21, as a result of which there is a possibility of illuminating the nozzle face 51 of the recording head 50. However, in the inkjet printer according to the present embodiment, since the reflection plate 71 and the reflection plate 172 are not parallel in the present embodiment, the occurrence of such a problem can be suppressed.

Further, in the inkjet printer according to the present embodiment, since the reflection plate 173 and the reflection plate not shown facing each other in the ultraviolet irradiating devices 160 are also not parallel, the occurrence of a similar problem can be suppressed also for the reflection plate 173 and the reflection plate not shown and facing the reflection plate 173.

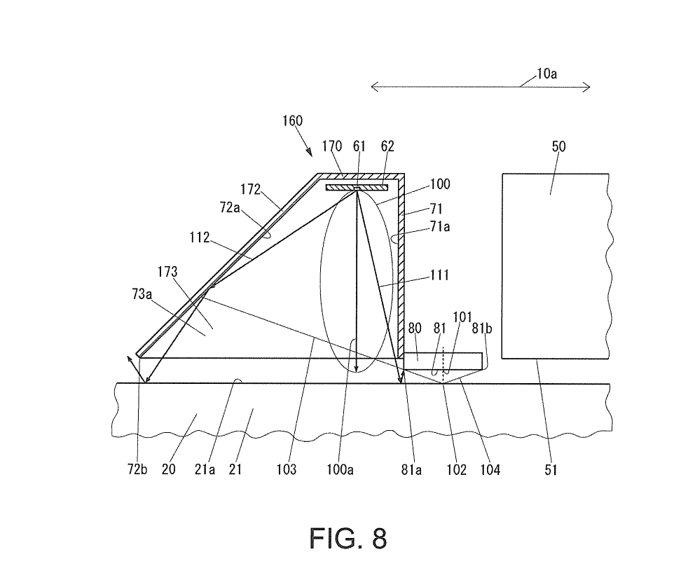

Further, the inkjet printer according to the present embodiment may have the reflection plate 172 disposed in a state of being tilted by 45° with respect to a perpendicular of the medium supporting face 21a in a state of being tilted with respect to the medium supporting unit 21 than in the state of vertically intersecting the medium supporting face 21a, or in a state of being tilted in a direction of being tilted with respect to the medium supporting unit 21 than in this state, in the case where the medium supporting face 21a of the medium supporting unit 21 is parallel to the main scanning direction shown by the arrow 10a and the sub scanning direction shown by the arrow 10b, as shown in FIG. 8. In the case of this configuration, in a case where a progressing direction of the ultraviolet ray radiated by the light sources 61 is a direction parallel to the medium supporting face 21a of the medium supporting unit 21, or in a direction approaching the medium supporting face 21a than this direction, the inkjet printer according to the present embodiment can prevent ultraviolet ray 112 within the ultraviolet ray radiated by the light sources 61 having an orientation for a component in the main scanning direction shown by the arrow 10a being an orientation separating away from the recording head 50 from having the orientation for the component in the main scanning direction shown by the arrow 10a come to be in an orientation approaching the recording head 50 by being reflected by the reflection plate 172; so the ultraviolet ray 112 reflected by the reflection plate 172 can be prevented from illuminating the nozzle face 51 of the recording head 50 by being reflected by the medium supporting face 21a.

Similarly, the inkjet printer according to the present embodiment may have the reflection plate 172 disposed in a state of being tilted by 45° with respect to the perpendicular of the medium supporting face 21a in the state of being tilted with respect to the medium supporting unit 21 than in a state of vertically intersecting a face of the print medium 90 on the light source 61 side, or in a state of being tilted in the direction of being tilted with respect to the medium supporting unit 21 than in this state, in a case where the face of the print medium 90 on the light source 61 side is parallel to the main scanning direction shown by the arrow 10a and the sub scanning direction shown by the arrow 10b. In the case of this configuration, in a case where a progressing direction of the ultraviolet ray radiated by the light sources 61 is a direction parallel to the face of the print medium 90 on the light source 61 side, or in a direction approaching the face of the print medium 90 on the light source 61 side than this direction, the inkjet printer according to the present embodiment can prevent ultraviolet ray 112 within the ultraviolet ray radiated by the light sources 61 having an orientation for a component in the main scanning direction shown by the arrow 10a being an orientation separating away from the recording head 50 from having the orientation for the component in the main scanning direction shown by the arrow 10a come to be in an orientation approaching the recording head 50 by being reflected by the reflection plate 172; so the ultraviolet ray 112 reflected by the reflection plate 172 can be prevented from illuminating the nozzle face 51 of the recording head 50 by being reflected by the face of the print medium 90 on the light source 61 side.

It should be noted that the inkjet printer according to the present embodiment is configured to have the center line 100a of the directivity of the light source 61 vertically intersect the medium supporting face 21a of the table 20 in the present embodiment as shown in FIG. 7, however, similar to the inkjet printer 10 according to the first embodiment, the inkjet printer may be disposed in a state where the ultraviolet irradiating device 160 is tilted than a state where the center line 100a of the directivity of the light source 61 intersects vertically to the medium supporting face 21a of the table 20, that is, in a state where an upper portion of the ultraviolet irradiating device 160 approaches the recording head 50 than in the state where the center line 100a of the directivity of the light source 61 intersects vertically to the medium supporting face 21a of the table 20.

In the inkjet printer according to the present embodiment, the recoding head 50 is moved relatively in the sub scanning direction shown by the arrow 10b with respect to the print medium 90 by moving the recoding head 50 in the sub scanning direction shown by the arrow 10b in the present embodiment; however, it may have a configuration other than the above configuration. For example, the inkjet printer according to the present embodiment may be configured to relatively move the recording head 50 in the sub scanning direction shown by the arrow 10b with respect to the print medium 90 by conveying the print medium 90 in the sub scanning direction shown by the arrow 10b.

### Third Embodiment

Firstly, a configuration of an inkjet printer according to a third embodiment of the present invention will be described.

It should be noted that among the components of the inkjet printer according to the present embodiment, components identical to the components of the inkjet printer 10 according to the first embodiment (see FIG. 1) will be given the same reference signs as the inkjet printer 10, and the detailed description thereof will be omitted.

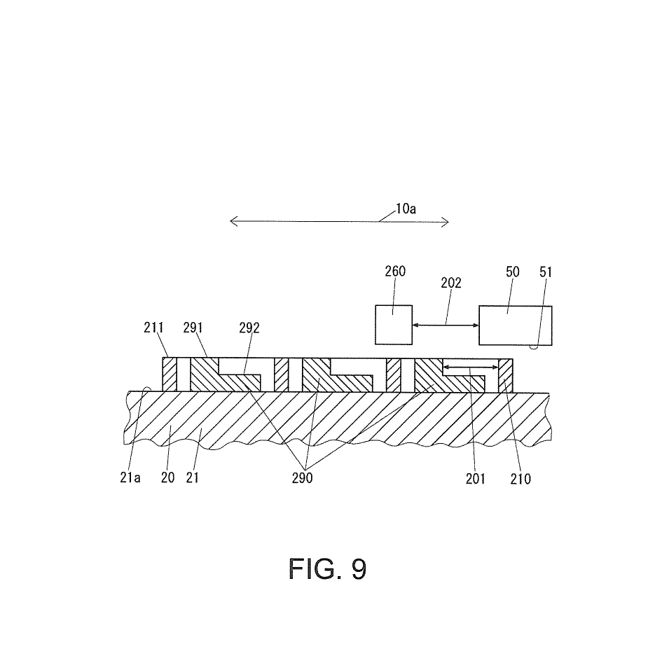

FIG. 9 is a front view of a vicinity of an ultraviolet irradiating device 260 of the inkjet printer according to the present embodiment.

It should be noted that FIG. 9 only shows the ultraviolet irradiating device 260 on a left side as seen from a front side of the inkjet printer, of the two ultraviolet irradiating devices 260 of the inkjet printer according to the present embodiment. Further, FIG. 9 omits a part of the configuration, such as the carriage 40 (see FIG. 1). In FIG. 9, a table 20, a light shielding wall 210, and a print medium 290 are shown in their cross section.

As shown in FIG. 9, the configuration of the inkjet printer according to the present embodiment is similar to a configuration in which the inkjet printer 10 (see FIG. 1) does not have the ultraviolet-absorbing light shielding plates 80 (see FIG. 1), and has the ultraviolet irradiating device 260 as the light irradiating device that irradiates ultraviolet curing ink discharged by a recording head 50 with ultraviolet ray instead of the ultraviolet irradiating devices 60 (see FIG. 1).

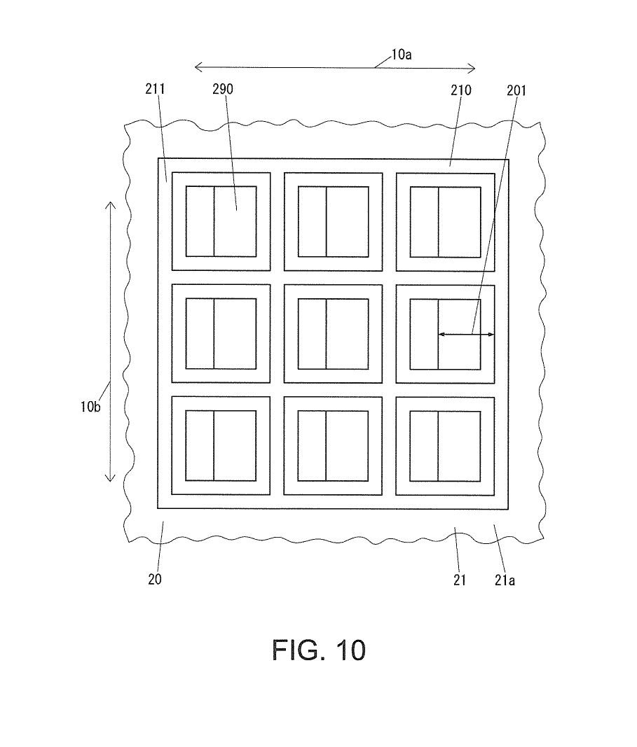

FIG. 10 is a plan view of a vicinity of the light shielding wall 210.

As shown in FIG. 9 and FIG. 10, the inkjet printer according to the present embodiment performs printing on a print medium 290 in a state of having the light shielding wall 210 for shielding light disposed to surround a periphery of the print medium 290 supported by the medium supporting unit 21.

A color of the light shielding wall 210 is a color that can absorb ultraviolet ray, such as black. For example, the light shielding wall 210 may have a carbon coating by an ultraviolet-absorbing paint, or a black coating by an ultraviolet-absorbing dye performed on its surface.

The print medium 290 includes a high print surface 291 being a print surface with a shorter distance from the nozzle face 51 at a time point when it is facing the nozzle face 51 of the recording head 50. Further, the print medium 290 includes a low print surface 292 being a print surface with a shorter distance from the medium supporting face 21a of the table 20 than a distance between the high print surface 291 and the medium supporting face 21a. That is, the distance between the nozzle face 51 and the high print surface 291 at the time point when the nozzle face 51 of the recording head 50 is facing the high print surface 291 is shorter than the distance between the nozzle face 51 and the low print surface 292 at the time point when the nozzle face 51 of the recording head 50 is facing the low print surface 292.

The light shielding wall 210 is formed such that a distance between a face 211 on an opposite side of the medium supporting face 21a of the table 20 side and the medium supporting face 21a becomes identical to the distance between the high print surface 291 of the print medium 290 and the medium supporting face 21a.

The light shielding wall 210 is formed such that a distance 201 from the high print surface 291 of the print medium 290 in the main scanning direction shown by the arrow 10a on the low print surface 292 side becomes shorter than a distance 202 between the recording head 50 and the ultraviolet irradiating device 260 in the main scanning direction shown by the arrow 10a.

Next, an inkjet printing method using the inkjet printer according to the present embodiment will be described.

The inkjet printer according to the present embodiment performs printing similar to the inkjet printer 10 (see FIG. 1) according to the first embodiment in a state of having the light shielding wall 210 and the print medium 290 disposed on the table 21 as shown in FIG. 9 and FIG. 10.

That is, the inkjet printer according to the present embodiment performs the discharge of the ultraviolet curing ink by the recording head 50 onto the print medium 290 and the ultraviolet irradiation by the ultraviolet irradiating device 260 onto the ultraviolet curing ink adhered to the print medium 290 in the state of having the light shielding wall 210 and the print medium 290 disposed on the table 21 as shown in FIG. 9 and FIG. 10.

Here, in the inkjet printing method according to the present embodiment, since the distance 201 between the high print surface 291 of the print medium 290 and the light shielding wall 210 on the low print surface 292 side with respect to the high print surface 291 in the main scanning direction shown by the arrow 10a is shorter than the distance 202 between the recording head 50 and the ultraviolet irradiating device 260 in the main scanning direction shown by the arrow 10a, the recording head 50 and the ultraviolet irradiating device 260 can be prevented from facing the low print surface 292 of the same print medium 290. That is, in the inkjet printing method according to the present embodiment, the ultraviolet ray ultraviolet ray radiated by the ultraviolet irradiating device 260 can be prevented from illuminating the nozzle face 51 of the recording head 50 after having been reflected by the low print surface 292 of the print medium 290, by the light shielding wall 210.

It should be noted that the longer distance 202 is more preferred from the viewpoint of preventing the ultraviolet ray radiated by the ultraviolet irradiating device 260 from illuminating the nozzle face 51 of the recording head 50 after having been reflected by the print medium 290, such as, for example, 200 mm. However, as described in the first embodiment, the upper limit of the distance 202 is determined by considering the distance that is obtained by multiplying the time until when the ultraviolet curing ink discharged by the recording head 50 and adhered onto the print medium 290 smears on the print medium 290 by the moving speeds of the recording head 50 and the ultraviolet irradiating devices 260 in the main scanning direction shown by the arrow 10a.

As described above, the inkjet printing method according to the present embodiment can prevent the ultraviolet ray radiated by the ultraviolet irradiating device 260 from illuminating the nozzle face 51 of the recording head 50 by the light shielding wall 210 after it has been reflected by the print medium 290, so that the function to prevent the ultraviolet ray radiated by the ultraviolet irradiating device 260 from illuminating the nozzle face 51 of the recording head 50 can be improved than in the conventional technique.

There is a possibility that the inkjet printer may generate wind that may cause changes in a progressing direction of the ultraviolet curing ink discharged by the recording head 50 by the movement of the recording head 50 in the main scanning direction shown by the arrow 10a. The print quality of the inkjet printer would be degraded when the progressing direction of the ultraviolet curing ink discharged by the recording head 50 is changed by such wind. The possibility that such wind is generated becomes higher for cases where the distance between the nozzle face 51 and the low print surface 292 at the time point when the nozzle face 51 of the recording head 50 is facing the low print surface 292 is longer than the distance between the nozzle face 51 and the high print surface 291 at the time point when the nozzle face 51 of the recording head 50 is facing the high print surface 291; that is, when the distance between the nozzle face 51 and the low print surface 292 at the time point when the nozzle face 51 of the recording head 50 is facing the low print surface 292 is long. However, in the inkjet printing method according to the present embodiment, the generation of the wind that would change the progressing direction of the ultraviolet curing ink discharged by the recording head 50 can also be suppressed by the light shielding wall 210, so that the print quality can be improved.

In the inkjet printer according to the present embodiment, the recoding head 50 is moved relatively in the sub scanning direction shown by the arrow 10b with respect to the print medium 290 by moving the recoding head 50 in the sub scanning direction shown by the arrow 10b in the present embodiment; however, it may have a configuration other than the above configuration. For example, the inkjet printer according to the present embodiment may be configured to relatively move the recording head 50 in the sub scanning direction shown by the arrow 10b with respect to the print medium 290 by conveying the print medium 290 in the sub scanning direction shown by the arrow 10b.

### Fourth Embodiment

Firstly, a configuration of an inkjet printing system according to a fourth embodiment of the present invention will be described.

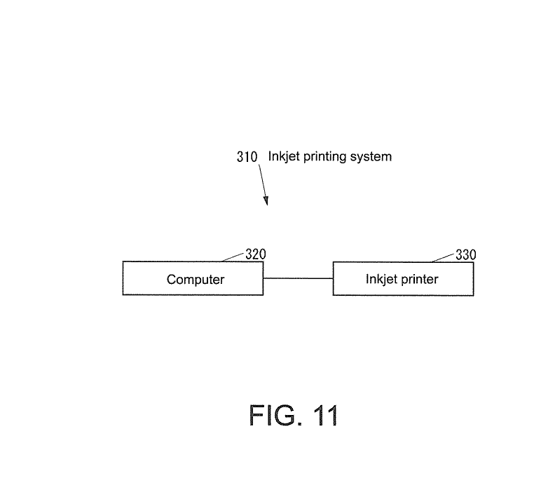

FIG. 11 is a block diagram of an inkjet printing system 310 according to the present embodiment.

As shown in FIG. 11, the inkjet printing system 310 includes a computer 320 such as a PC (Personal Computer), and an inkjet printer 330 connected to the computer 320 so as to be capable of communicating and performing inkjet printing.

It should be noted that among the components of the inkjet printer 330, components identical to the components of the inkjet printer according to the third embodiment will be given the same reference signs as the inkjet printer according to the third embodiment, and the detailed description thereof will be omitted.

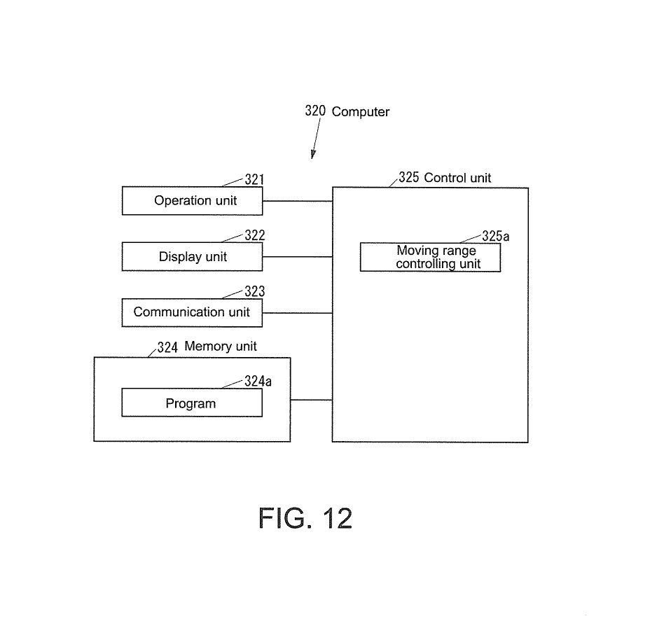

FIG. 12 is a block diagram of the computer 320.

As shown in FIG. 12, the computer 320 includes an operation unit 321 that is an input device such as a keyboard or a mouse by which various operations by a user are to be input, a display unit 322 that is a display device such as a LCD (Liquid Crystal Display) for displaying various types of information, a communication unit 323 being a communication device that performs communication with the inkjet printer 330 (see FIG. 11), a memory unit 324 being a storage device such as a HDD (Hard Disk Drive) that stores various types of data, and a control unit 325 that controls an entirety of the computer 320.

The memory unit 324 stores a program 324a for controlling the inkjet printer 330.

The control unit 325 for example includes a CPU (Central Processing Unit), a ROM (Read Only Memory) that stores the program and various types of data in advance, and a RAM (Random Access Memory) used as a work area for the CPU. The CPU is configured to execute the program stored in the ROM or the memory unit 324.

The control unit 325 functions as a moving range controlling unit 325a that controls a moving range of the recording head 50 (see FIG. 9) in the main scanning direction shown by the arrow 10a (effective scanning width) by executing the program 324a stored in the memory unit 324.

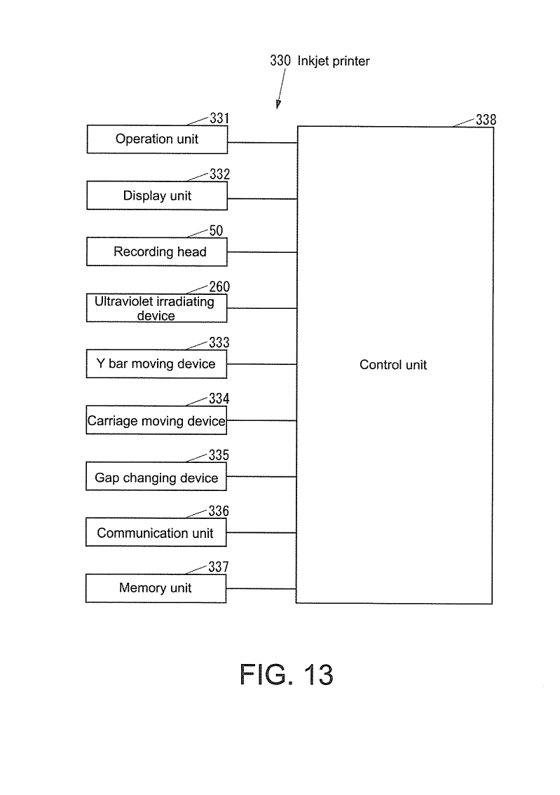

FIG. 13 is a block diagram of the inkjet printer 330.

As shown in FIG. 13, the inkjet printer 330 includes an operation unit 331 being an input device such as a button by which various operations by the user are to be input, a display unit 332 being a display device such as a LCD to display various types of information, a recording head 50 (see FIG. 9), an ultraviolet irradiating device 260 (see FIG. 9), a Y bar moving device 333 that moves a Y bar 30 (see FIG. 1) in a sub scanning direction shown by an arrow 10b (see FIG. 1) with respect to a table 20 (see FIG. 1), a carriage moving device 334 that moves a carriage 40 (see FIG. 1) in a main scanning direction shown by an arrow 10a (see FIG. 1) with respect to the Y bar 30, a gap changing device 335 that changes the distance 202 (see FIG. 9) that is a gap between the recording head 50 and the ultraviolet irradiating device 260 in the main scanning direction shown by the arrow 10a by moving the ultraviolet irradiating device 260 with respect to the recording head 50 on the carriage 40 in the main scanning direction shown by the arrow 10a, a communication unit 336 being a communication device that performs communication with the computer 320 (see FIG. 11), a memory unit 337 being a storage device such as an EEPROM (Electrically Erasable Programmable Read Only Memory) storing various types of data, and a control unit 338 that controls an entirety of the inkjet printer 330.

The control unit 338 for example includes a CPU, a ROM that stores programs and various types of data in advance, and a RAM used as a work area for the CPU. The CPU is configured to execute the program stored in the ROM or the memory unit 337.

Next, an operation of the inkjet printing system 310 will be described.

Firstly, the operation of the inkjet printing system 310 in the case of changing the gap of the recording head 50 and the ultraviolet irradiating device 260 in the main scanning direction shown by the arrow 10a will be described.

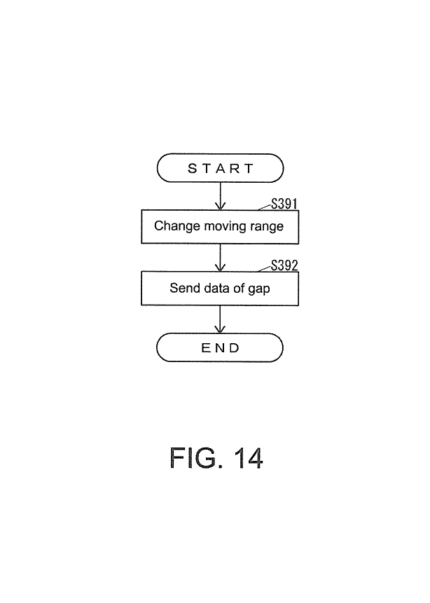

When the user instructs the computer 320 to change the gap of the recording head 50 and the ultraviolet irradiating device 260 in the main scanning direction shown by the arrow 10a via the operation unit 321, the control unit 325 of the computer 320 executes the operation shown in FIG. 14.

FIG. 14 is a flowchart of the operation by the computer 320 in the case of changing the gap of the recording head 50 and the ultraviolet irradiating device 260 in the main scanning direction shown by the arrow 10a.

As shown in FIG. 14, the control unit 325 of the computer 320 changes the moving range of the recording head 50 in the main scanning direction shown by the arrow 10a by the moving range controlling unit 325a (S391). Here, the moving range controlling unit 325a decreases the moving range in the main scanning direction shown by the arrow 10a according to an increase of the gap of the recording head 50 and the ultraviolet irradiating device 260 in the main scanning direction shown by the arrow 10a, and increases the moving range in the main scanning direction shown by the arrow 10a according to a decrease in the gap of the recording head 50 and the ultraviolet irradiating device 260 in the main scanning direction shown by the arrow 10a.

Next, the control unit 325 sends the data of the aforementioned gap instructed by the user via the operation unit 321 to the inkjet printer 330 via the communication unit 323 (S392), and ends the operation shown in FIG. 14.

When the data of the gap sent form the computer 320 is received via the communication unit 336, the control unit 338 of the inkjet printer 330 changes the gap between the recording head 50 and the ultraviolet irradiating device 260 in the main scanning direction shown by the arrow 10a by controlling the gap changing device 335 based on this data.

It should be noted that in a case of generating print data to be sent to the inkjet printer 330 according to the instruction of the user, the control unit 325 of the computer 320 generates the print data in the moving range changed in S391.

Next, an operation of the inkjet printing system 310 in a case of performing printing will be described.

When the user instructs the computer 320 to print an image by the inkjet printer 330 via the operation unit 321, the control unit 325 of the computer 320 sends the print data to the inkjet printer 330 via the communication unit 323.

When the print data sent from the computer 320 is received via the communication unit 336, the control unit 338 of the inkjet printer 330 prints the image on the print medium 290 (see FIG. 9) by controlling the recording head 50, the ultraviolet irradiating device 260, the Y bar moving device 333, and the carriage moving device 334 based on this print data.

As described above, the inkjet printing system 310 can prevent the ultraviolet ray with the orientation for a component in the main scanning direction shown by the arrow 10a being the orientation that approaches the recording head 50, within the ultraviolet ray radiated by the ultraviolet irradiating device 260, from illuminating the nozzle face 51 of the recording head 50 after it has been reflected by the medium supporting unit 21 or the print medium 290 supported by the medium supporting unit 21, by the increase in the gap between the recording head 50 and the ultraviolet irradiating device 260 in the main scanning direction shown by the arrow 10a, so that the function to prevent the ultraviolet ray radiated by the ultraviolet irradiating device 260 from illuminating the nozzle face 51 of the recording head 50 can be improved than in the conventional technique.

Further, since the inkjet printing system 310 automatically decreases the moving range of the recording head 50 in the main scanning direction shown by the arrow 10a in accordance with the increase in the gap between the recording head 50 and the ultraviolet irradiating device 260 in the main scanning direction shown by the arrow 10a, convenience can be improved.

It should be noted that although the inkjet printing system of the present invention includes the computer 320 in the present embodiment, it may be configured only by the inkjet printer 330. That is, the moving range controlling unit of the present invention may be configured by the control unit 338 of the inkjet printer 330.

In the inkjet printer 330, in the present embodiment, the recoding head 50 is moved relatively in the sub scanning direction shown by the arrow 10b with respect to the print medium 290 by moving the recoding head 50 in the sub scanning direction shown by the arrow 10b; however, it may have a configuration other than the above configuration. For example, the inkjet printer 330 may be configured to relatively move the recording head 50 in the sub scanning direction shown by the arrow 10b with respect to the print medium 290 by conveying the print medium 290 in the sub scanning direction shown by the arrow 10b.

### Fifth Embodiment

Firstly, a configuration of an inkjet printer according to a fifth embodiment of the present invention will be described.

It should be noted that among the components of the inkjet printer according to the present embodiment, components identical to the components of the inkjet printer of the third embodiment will be given the same reference signs as the inkjet printer according to the third embodiment, and the detailed description thereof will be omitted.

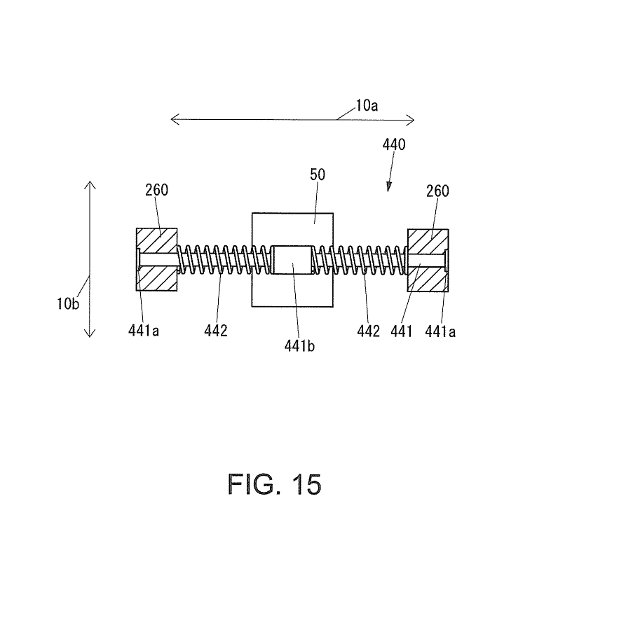

FIG. 15 is an upper face sectional view of a vicinity of a carriage 440 of the inkjet printer according to the present embodiment.

It should be noted that FIG. 15 omits a part of the configuration, such as the table 20 (see FIG. 1).

As shown in FIG. 15, the carriage 440 includes a shaft member 441 that supports the ultraviolet irradiating device 260 so as to be movable in the main scanning direction shown by the arrow 10a, and a spring 442 that is wound on the shaft member 441 and biases the ultraviolet irradiating device 260 in a direction that separates away from the recording head 50 along the main scanning direction shown by the arrow 10a. The recording head 50 is fixed to the shaft member 441. That is, the carriage 440 supports the recording head 50 and the ultraviolet irradiating device 260 while providing the bias in the direction along which the gap between the recording head 50 and the ultraviolet irradiating device 260 becomes large along the main scanning direction shown by the arrow 10a, and it configures the bias supporting unit of the present invention.

The shaft member 441 includes flanges 441a provided at its both ends for preventing the ultraviolet irradiating device 260 from moving in the direction of separating away from the recording head 50 along the main scanning direction shown by the arrow 10a by contacting the ultraviolet irradiating device 260. Accordingly, the ultraviolet irradiating device 260 stops at the end of the shaft member 441 even if it moves in the direction of separating away from the recording head 50 along the main scanning direction shown by the arrow 10a by being biased by the spring 442.

The shaft member 441 includes a flange 441b at its center for preventing the spring 442 from moving in a direction of approaching the center of the shaft member 441 along the main scanning direction shown by the arrow 10a by contacting the spring 442.

The spring 442 is provided for each of the two ultraviolet irradiating devices 260 of the inkjet printer according to the present embodiment. One end of the spring 442 is in contact with the ultraviolet irradiating device 260.

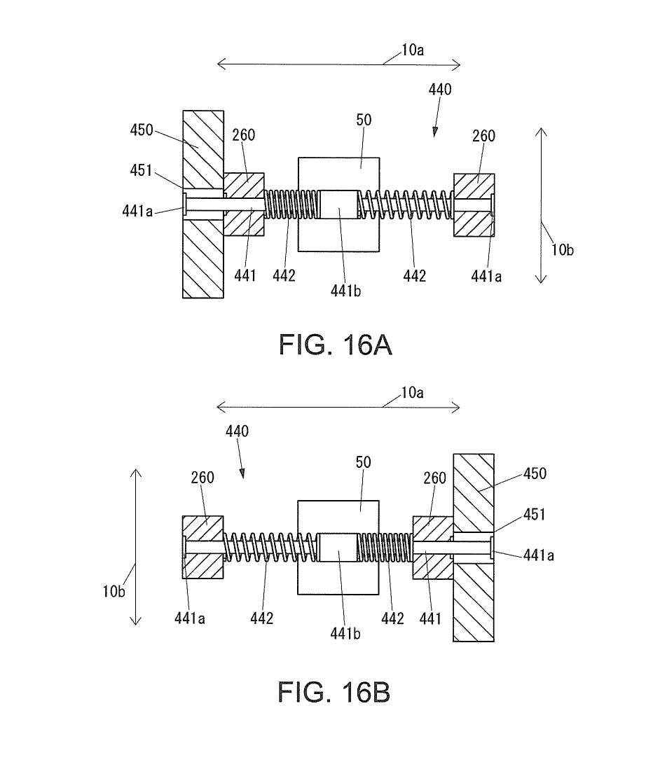

FIG. 16A is an upper face sectional view of the vicinity of the carriage 440 at one end side of the main scanning direction shown by the arrow 10a of the inkjet printer according to the present embodiment. FIG. 16B is an upper face sectional view of the vicinity of the carriage 440 at the other end side of the main scanning direction shown by the arrow 10a of the inkjet printer according to the present embodiment.

It should be noted that FIG. 16A and FIG. 16B omit a part of the configuration, such as the table 20 (see FIG. 1).

As shown in FIG. 16A and FIG. 16B, the inkjet printer according to the present embodiment includes movement restricting units 450 provided in the Y bar 30 (see FIG. 1), which restrict movement of the ultraviolet irradiating device 260 in the main scanning direction shown by the arrow 10a by contacting the ultraviolet irradiating device 260.

The movement restricting units 450 are disposed at both ends of the moving range of the ultraviolet irradiating device 260 in the main scanning direction shown by the arrow 10a.

The movement restricting unit 450 has a hole 451 for passing a part of the shaft member 441 through formed therein. The hole 451 has a size that allows the shaft member 441 to pass through, but does not allow the ultraviolet irradiating device 260 to pass through.

It should be noted that arrangements of the recording head 50, the ultraviolet irradiating device 260, the carriage 440, and the movement restricting units 450 are designed such that the position of the recording head 50 in the case where the ultraviolet irradiating device 260 is making contact with the movement restricting unit 450 comes to be outside a printing range in the main scanning direction shown by the arrow 10a.

Further, the ultraviolet irradiating device 260 is configured to automatically stop the irradiation of the ultraviolet ray in the case where the recording head 50 is present at the position outside the printing range in the main scanning direction shown by the arrow 10a, by some sort of hardware-based mechanism such as a contact between mechanical parts on a circuit that supplies electric power to the ultraviolet irradiating device 260 being released, or by some sort of software-based mechanism such as the control unit of the inkjet printer of the present embodiment stopping the irradiation of the ultraviolet ray by the ultraviolet irradiating device 260 according to a signal from a sensor detecting the presence of the recording head 50 at the position outside the printing range in the main scanning direction shown by the arrow 10a.

Next, an operation of the inkjet printer according to the present embodiment will be described.

The inkjet printer according to the present embodiment can perform printing similar to the inkjet printer 10 (see FIG. 1) according to the first embodiment.

Here, in the case where the ultraviolet irradiating device 260 is not making contact with the movement restricting unit 450, the carriage 440 is supporting the ultraviolet irradiating device 260 in the main scanning direction shown by the arrow 10a as shown in FIG. 15, while it is sufficiently separated away from the recording head 50. On the other hand, in the case where the ultraviolet irradiating device 260 has made contact with the movement restricting unit 450 by moving to the end of the moving range of the ultraviolet irradiating device 260 in the main scanning direction shown by the arrow 10a, the carriage 440 supports the ultraviolet irradiating device 260 by bringing it closer to the recording head 50 by the sprint 442 being contracted by the ultraviolet irradiating device 260 making contact with the movement restricting unit 450 as shown in FIG. 16A and FIG. 16B.

It should be noted that in the case where the ultraviolet irradiating device 260 is making contact with the movement restricting unit 450, the recording head 50 is present at the position outside the printing range in the main scanning direction shown by the arrow 10a. Here, as described above, in the case where the recording head 50 is present at the position outside the printing range in the main scanning direction shown by the arrow 10a, the ultraviolet irradiating device 260 stops the irradiation of the ultraviolet ray. Accordingly, the ultraviolet irradiating device 260 stops the irradiation of the ultraviolet ray in the case of making contact with the movement restricting unit 450, that is, in the case where its movement is restricted by the movement restricting units 450.

As described above, the inkjet printer according to the present embodiment can prevent the ultraviolet ray with the orientation for the component in the main scanning direction shown by the arrow 10a being the orientation that approaches the recording head 50, within the ultraviolet ray radiated by the ultraviolet irradiating device 260, from illuminating the nozzle face 51 of the recording head 50 (see FIG. 9) after it has been reflected by the medium supporting unit 21 (see FIG. 9) or the print medium 290 supported by the medium supporting unit 21, by the increase in the gap between the recording head 50 and the ultraviolet irradiating device 260 in the main scanning direction shown by the arrow 10a at the time point when the ultraviolet curing ink adhered to the print medium 290 (see FIG. 9) is irradiated with ultraviolet ray by the ultraviolet irradiating device 260, as a result of which the function to prevent the ultraviolet ray radiated by the ultraviolet irradiating device 260 from illuminating the nozzle face 51 of the recording head 50 can be improved than in the conventional technique.

Further, since in the inkjet printer according to the present embodiment, the gap between the recording head 50 and the ultraviolet irradiating device 260 in the main scanning direction shown by the arrow 10a can be reduced by the movement restricting unit 450 making contact with the ultraviolet irradiating device 260 at the end of the moving range of the ultraviolet irradiating device 260 in the main scanning direction shown by the arrow 10a, even if the gap between the recording head 50 and the ultraviolet irradiating device 260 in the main scanning direction shown by the arrow 10a at the time point when the ultraviolet curing ink adhered onto the print medium 290 is irradiated with ultraviolet ray by the ultraviolet irradiating device 260 is provided sufficiently, the moving range of the recording head 50 in the main scanning direction shown by the arrow 10a can be prevented from being reduced.

Further, the inkjet printer according to the present embodiment can prevent the ultraviolet ray radiated by the ultraviolet irradiating device 260 from illuminating the nozzle face 51 of the recording head 50 after it has been reflected by the medium supporting unit 21 or the print medium 290 supported by the medium supporting unit 21 at the end of the moving range of the ultraviolet irradiating device 260 in the main scanning direction shown by the arrow 10a, since the ultraviolet irradiation by the ultraviolet irradiating device 260 is automatically stopped at the time point when the gap between the recording head 50 and the ultraviolet irradiating device 260 in the main scanning direction shown by the arrow 10a is reduced at the end of the moving range of the ultraviolet irradiating device 260 in the main scanning direction shown by the arrow 10a.

In the inkjet printer according to the present embodiment, the recoding head 50 is moved relatively in the sub scanning direction shown by the arrow 10b with respect to the print medium 290 by moving the recoding head 50 in the sub scanning direction shown by the arrow 10b in the present embodiment; however, it may have a configuration other than the above configuration. For example, the inkjet printer according to the present embodiment may be configured to relatively move the recording head 50 in the sub scanning direction shown by the arrow 10b with respect to the print medium 290 by conveying the print medium 290 in the sub scanning direction shown by the arrow 10b.

### DESCRIPTION OF REFERENCE SIGNS

10: Inkjet printer

10a: Arrow (arrow showing main scanning direction)

10b: Arrow (arrow showing sub scanning direction)

21: Medium supporting unit

50: Recording head

51: Nozzle face

60: Ultraviolet irradiating device (light irradiating device)

61: Light source

72: Reflection plate (opposite-side reflecting unit)

72b: End

80: Ultraviolet-absorbing light shielding plate (light shielding unit)

81a: End point (end point on light source side)

90: Print medium

101: Point (center point of light shielding unit)

102: Point (intersection point of perpendicular)

103: Line

111: Ultraviolet ray (light)

112: Ultraviolet ray (light)

160: Ultraviolet irradiating device (light irradiating device)

172: Reflection plate (opposite-side reflecting unit)

210: Light shielding wall

260: Ultraviolet irradiating device (light irradiating device)

290: Print medium

310: Inkjet printing system

325a: Moving range controlling unit

330: Inkjet printer

440: Carriage (bias supporting unit)

450: Movement restricting unit

1. An inkjet printer, comprising:
a medium supporting unit that supports a print medium;
a recording head having a nozzle face formed to face the medium supporting unit, nozzles that discharge photocuring ink toward the print medium supported on the medium supporting unit being formed on the nozzle face, the photocuring ink configured to cure by light irradiation;
a light irradiating device that irradiates the photocuring ink discharged by the recording head and adhered onto the print medium with light; and
a light shielding unit that shields the light radiated by the light irradiating device,
wherein the light irradiating device includes a light source that radiates light,
the light shielding unit has a position in an aligned direction of the recording head and the light source that is between a position of the recording head in the aligned direction and a position of the light source in the aligned direction, and
the light source is disposed on a line or on a center point side with respect to the line, the line passing through an intersection point of a perpendicular drawn from a center point of the light shielding unit in the aligned direction to the medium supporting unit and an end point of the light shielding unit on a light source side in the aligned direction.

2. The inkjet printer according to claim 1, wherein
the aligned direction is a scanning direction of the recording head.

3. The inkjet printer according to claim 1, wherein
the light irradiating device includes an opposite-side reflecting unit that is disposed on an opposite side from the recording head side with respect to the light source in the aligned direction and that reflects the light radiated by the light source, and
an end of the opposite-side reflecting unit on the medium supporting unit side is disposed on the line or on the center point side with respect to the line.

4. The inkjet printer according to claim 1, wherein
the light irradiating device includes an opposite-side reflecting unit that is disposed on an opposite side from the recording head side with respect to the light source in the aligned direction and that reflects the light radiated by the light source, and
the opposite-side reflecting unit is disposed in a state of vertically intersecting the line, or in a state of being tilted in a direction by which the opposite-side reflecting unit is tilted with respect to the medium supporting unit.

5. An inkjet printing method using an inkjet printer that includes a medium supporting unit that supports a print medium; a recording head having a nozzle face foamed to face the medium supporting unit, nozzles that discharge photocuring ink toward the print medium supported on the medium supporting unit being formed on the nozzle face, the photocuring ink configured to cure by light irradiation; and a light irradiating device that irradiates the photocuring ink discharged by the recording head and adhered onto the print medium with light, the inkjet printing method comprising:
performing discharge of the photocuring ink by the recording head onto the print medium and light irradiation by the light irradiating device onto the photocuring ink adhered to the print medium in a state where a light shielding wall that shields light is disposed to surround a periphery of the print medium supported by the medium supporting unit.

6. An inkjet printing system, comprising:
a medium supporting unit that supports a print medium;
a recording head having a nozzle face formed to face the medium supporting unit, nozzles that discharge photocuring ink toward the print medium supported on the medium supporting unit being formed on the nozzle face, the photocuring ink configured to cure by light irradiation;
a light irradiating device that moves together with the recording head in a scanning direction of the recording head and irradiates the photocuring ink discharged by the recording head with light; and
a moving range controlling unit that controls a moving range of the recording head in the scanning direction,
wherein the moving range controlling unit decreases the moving range in accordance with an increase in a gap along the scanning direction between the recording head and the light irradiating device.

7. An inkjet printer, comprising:
a medium supporting unit that supports a print medium;
a recording head having a nozzle face formed to face the medium supporting unit, nozzles that discharge photocuring ink toward the print medium supported on the medium supporting unit being formed on the nozzle face, the photocuring ink configured to cure by light irradiation;
a light irradiating device that moves together with the recording head in a scanning direction of the recording head and irradiates the photocuring ink discharged by the recording head with light;
a bias supporting unit that supports the recording head and the light irradiating device while biasing in a direction along which a gap between the recording head and the light irradiating device in the scanning direction increases; and
a movement restricting unit that is disposed at an end of a moving range of the light irradiating device in the scanning direction and restricts a movement of the light irradiating device in the scanning direction by making contact with the light irradiating device.

8. The inkjet printer according to claim 7, wherein
the light irradiating device stops the light irradiation when movement is restricted by the movement restricting unit.
